(19) United States
(12) Patent Application Publication
(10) Pub. No.: US 2002/0169697 A1
(43) Pub. Date: Nov. 14, 2002

(54) Replacement part tracking for steam turbines

(76) Inventors: Joshua Farrell Hicks, Kennesaw, GA (US); Mark J. Scoretz, Kennesaw, GA (US); Daniel E. Barnard, Marietta, GA (US); John Milner Hess, Marietta, GA (US)

Correspondence Address: PERKINS COIE LLP, PATENT-SEA, P.O. BOX 1247, SEATTLE, WA, 98111-1247, US

(21) Appl. No.: 10/081,924

(22) Filed: Feb. 20, 2002

Related U.S. Application Data
(63) Continuation-in-part of application No. 09/750,485, filed on Dec. 27, 2000.

(51) Int. Cl. G06F 17/60

(52) U.S. Cl. 705/28

(57) ABSTRACT

Legacy parts information for steam turbines is made accessible via a database which employs hierarchical parts groupings, distribution codes, categories, and plain language parts titles and/or descriptions. In one embodiment, the invention provides a process for receiving legacy parts information and modifying the legacy parts information to create the computer searchable database in a fashion which facilitates easier searching.

### CROSS-REFERENCE TO RELATED APPLICATION(S)

The present application is a continuation-in-part of U.S. application Ser. No. 09/750,485, entitled “Method, Apparatus and Article for Tracking Replacement Part Information,” filed Dec. 27, 2000, the entire teachings of which are incorporated herein by reference.

### TECHNICAL FIELD

This invention is generally related to the tracking of information regarding replacement parts, and particularly to the provision of replacement part information to assist in the identification and/or sales of replacement parts for steam turbines.

### BACKGROUND

Steam turbines are large, complex machines having thousands of individual parts. When designing a new steam turbine, engineers will identify these parts in one or more engineering parts lists, e.g., a master parts list or a series of parts lists associated with each of a number of different engineering drawings. While more recently developed steam turbines may have these engineering parts lists in computer-readable form, some older steam turbines will not.

As the steam turbine design moves from the engineering/design phase toward commercial manufacture, the engineering parts lists may evolve into manufacturing-oriented parts lists or bills of material. In this process, much of the information associated with individual parts in the engineering parts list may be omitted or modified. For example, a generic parts designation in the engineering parts list may be rewritten in a bill of material to specify a particular supplier or grade of material. Commonly, however, these lists will carry at least one consistent identifier from one list to another. For example, an item number from the master parts list or drawing list line number, and/or a keyword, may remain unchanged between the original master parts list and a later, manufacturing-oriented bill of material.

Steam turbines must be maintained after they are installed. Some individual parts or assemblies are designed to be replaced at regular intervals. Other parts may break or malfunction from time to time and require replacement. It can be difficult for a service technician, who may be employed by the purchaser of the steam turbine or by a third-party service company, to identify the particular part or parts needed for a given project in a fashion which enables the original steam turbine manufacturer to identify the part for shipment.

Tracking the parts from a single steam turbine can be difficult. Large manufacturing companies may produce many different steam turbine designs over the course of time, with each steam turbine design having its own, unique parts list or lists. These machines may be designed and built at a variety of different company locations. Some of these machines may be manufactured as a staple item, with or without change, over an extended period of time while other models may be custom designs or manufactured for only a relatively short period of time. Steam turbine manufacturers often wish to supply replacement parts for some or all of the steam turbines it has sold. Tracking the various replacement parts for each of its products can be a an expensive, time-consuming activity for the manufacturer.

### SUMMARY

Various embodiments of the invention provide methods and systems to facilitate access to steam turbine machine part data. In one embodiment of the invention, a method of providing searchable access to steam turbine machine part data includes receiving a first set of legacy parts information. The legacy parts information includes a unique part identifier for each of a plurality of unique steam turbine parts and the legacy parts information may have an abbreviated text description of at least some of the parts. This abbreviated text description may use jargon and shorthand notation, which may make it difficult for service technicians and others to readily search and understand the descriptions. In accordance with the method, each of the abbreviated text descriptions are translated into a plain language title. This plain language title is associated with the part identifier for the part in an entry in a computer searchable database. A user interface is provided for accessing the parts information by way of the plain language parts descriptions.

In one adaptation of this embodiment, a search request is received in the form of a plain language parts query. At least one part that corresponds to the received plain language parts query is automatically located by searching the plain language titles in the database. The method may further include transmitting item information for at least one salable item that includes the located part and at least one other part.

Another embodiment of the invention provides a system for facilitating access to machine parts information. This system may include a processor coupled to a first set of legacy parts information. This legacy parts information may include a unique part identifier for each of a plurality of unique steam turbine parts and an abbreviated text description of at least some of the parts. The processor is programmed to translate each of the abbreviated text descriptions into a plain language title and associate the plain language title with the part identifier for the part in an entry in a computer searchable database.

### BRIEF DESCRIPTION OF THE DRAWINGS

In the drawings, identical reference numbers identify similar elements or acts. The size and relative positions of elements in the drawings are not necessarily drawn to scale. For example, the shapes of various elements are not drawn to scale, and some of these elements are arbitrarily enlarged and positioned to improve drawing legibility. Further, the particular shapes of elements, as drawn, are not intended to convey any information regarding the actual shape of the particular elements, and have been solely selected for their ease and recognition in the drawings.

FIG. 1 is a schematic drawing showing an environment in which an embodiment of the invention can operate, including a network coupling a number of client computing systems and a server computing system.

FIG. 2 is a high level system block diagram showing various hardware elements of the client computing systems of FIG. 1.

FIG. 3 is a schematic diagram of a bill of materials data structure, a translation data structure and a response data structure, each illustrated in table form.

FIG. 4 is a flow diagram illustrating a method of providing legacy parts information in a computer-searchable form.

FIG. 5 is a flow diagram illustrating a method of accessing parts information.

### DETAILED DESCRIPTION

In the following description, certain specific details are set forth in order to provide a thorough understanding of various embodiments of the invention. However, one skilled in the art will understand that the invention may be practiced without these details. In other instances, well-known structures associated with computers, computer networks, data structures, databases and networks such as the Internet, have not been described in detail to avoid unnecessarily obscuring the descriptions of the embodiments of the invention.

Unless the context requires otherwise, throughout the specification and claims which follow, the word “comprise” and variations thereof, such as “comprises” and “comprising” are to be construed in an open, inclusive sense, that is as “including but not limited to.”

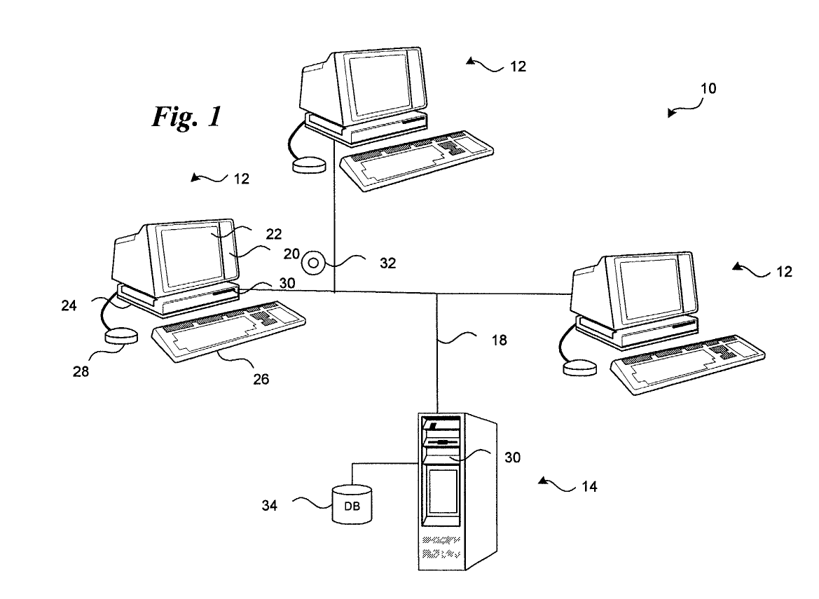

FIG. 1 shows a parts identification and tracking system 10 including a number of client computing systems 12 and a server computing system 14 that communicate over a network. The network 18 can take the form of any conventional network, such as one or more local area networks (“LANs”), wide area networks (“WANs”), and/or extranets, intranets, or the Internet, e.g., the World Wide Web portion of the Internet. The client computing systems 12 each include a display 20, screen 22, cabinet 24, keyboard 26 and mouse 28. The mouse 28 can have one or more user selectable buttons for interacting with a graphical user interface (“GUI”) displayed on the screen 22. The cabinet 24 includes a slot 30 for receiving computer-readable media, such as a CD-ROM disk 32. Although the computer-readable media is represented as a CD-ROM disk 32, the parts identification and tracking system 10 can employ other computer-readable media, including but not limited to, floppy disks, tape, flash memory, system memory, and hard drives.

The server computing system 14 includes a cabinet 24 having a slot 30 for receiving computer-readable media, such as a CD-ROM disk similar to the CD-ROM disk 32. The server computing system 14 can optionally include a display, screen, keyboard, and/or mouse as described above. The server computing system 14 also includes a server database 34. The server database 34 is shown as being external to the cabinet 24 for ease of representation in the drawings, although in many embodiments the server database 34 can be located within the cabinet 24.

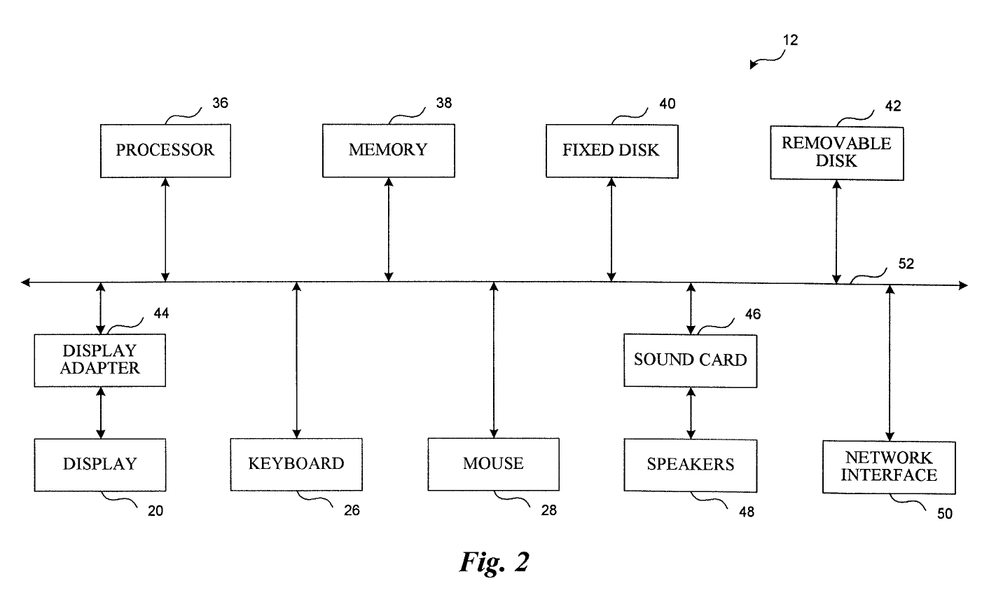

FIG. 2 shows a system block diagram of the client computing systems 12 used in executing an illustrated embodiment of the present invention. As in FIG. 1, the client computing systems 12 each include the display 20, keyboard 26 and mouse 28. Additionally, each of the client computing systems 12 can include subsystems, such as a processor 36, system memory 38, fixed persistent memory 40, media drive 42, display adapter 44, sound card 46, speakers 48, and network interface 50. Arrows 52 represent the system bus architecture of the client computing systems 12.

The client computing systems 12 can take any of a variety of forms, such as a micro- or personal computer, a mini-computer, a workstation, or a palm-top or hand-held computing appliance. The processor 36 can take the form of any suitable microprocessor, for example, a Pentium Ill, Pentium IV, Power PC 603 or Power PC 604 processor. The system memory 38 can take the form of random access memory (“RAM”) or other dynamic storage that temporarily stores instructions and data for execution by the processor 36. The fixed persistent memory 40 can take the form of a hard drive or other nonvolatile computer-readable media. The media drive 42 can take the form of a CD-ROM reader, DVD reader, optical disk reader, floppy disk reader, or other similar device that reads instructions and/or data from computer-readable media.

While not shown in detail, the server computing system 14 can have a similar structure to the client computing systems 12, as shown in FIG. 2. In practice, the server computing system will typically take the form of a Web server, the details of which are commonly understood by those skilled in the art. The server computing system 14 employs database software, such as structured query language (“SQL”) software, to store and retrieve data within the server database 34.

The computing systems 12, 14 are illustrative of the numerous computing systems suitable for use with the present invention. Other suitable configurations of computing systems will be readily apparent to one of ordinary skill in the art. Other configurations can include additional subsystems, or fewer subsystems, as is suitable for the particular application. For example, a suitable computing system 12, 14 can include more than one processor 36 (i.e., a multiprocessor system) and/or a cache memory. The arrows 52 are illustrative of any interconnection scheme serving to link the subsystems. Other suitable interconnection schemes will be readily apparent to one skilled in the art. For example, a local bus could be utilized to connect the processor 36 to the system memory 38 and the display adapter 34.

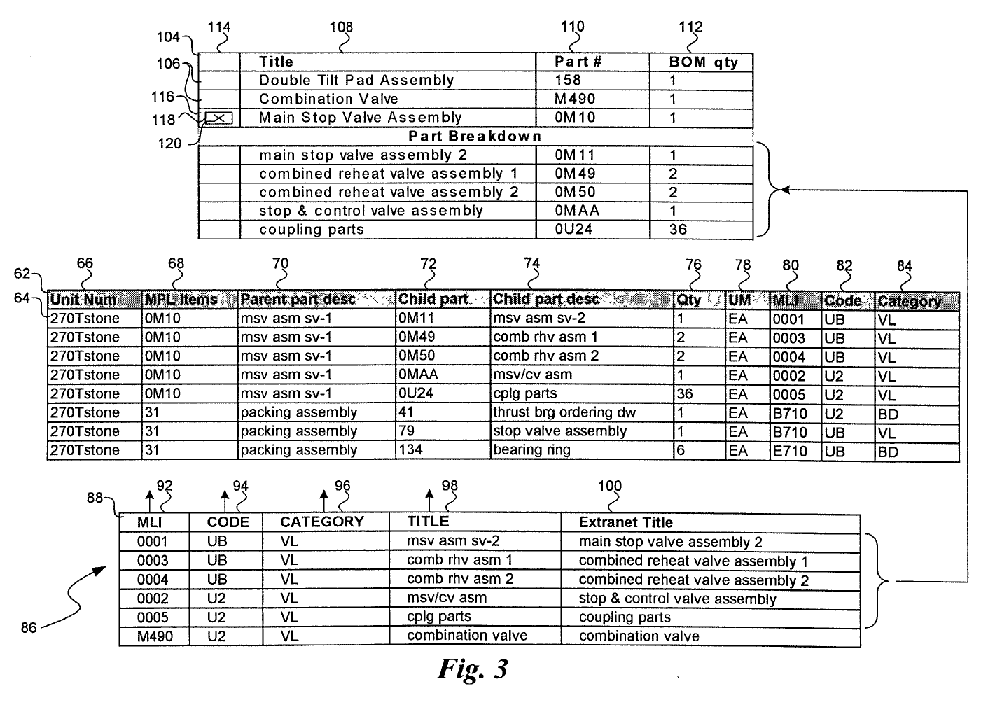

FIG. 3 shows a portion of a bill of material data structure 60 for a particular machine, such as a steam turbine. The bill of material data structure 60 is illustrated as a bill of material table 62 including parts information for the various parts of the steam turbine, although other formats may be suitable. The bill of material data structure 60 can take the form of a computer-readable file resulting directly from the design/manufacturing process, or can be a computer-readable file populated from a prior existing set of legacy data, such as by typing or scanning data from a paper bill of material.

The bill of material table 62 includes a number of rows 64 corresponding to the individual parts and/or groups of parts forming the steam turbine. The bill of material table 62 includes a number of columns for detailing information regarding each of the parts. For example, a “unit identifier” column 66 (“Unit Num”) contains an identifier such as a serial number for a unit to which the corresponding part belongs. The unit identifier can, for example, identify a particular steam turbine model. A “parent” column 68 (“MPL items”) identifies an assembly or sub-assembly to which the part belongs, if any. For example, a bearing ring may be a component of a packing assembly. A “parent part description” column 70 (“Parent part desc”) provides a brief textual description of the assembly or sub-assembly. Often, the designers and engineers create the brief textual description, and intend the description only for internal use. Thus, the brief textual description is typically cryptic, employing jargon such as abbreviations and acronyms that are not readily understood by those who are not intimately familiar with the machine. For example, the textual description for a stop and control valve assembly may be “MSV/CV ASM.”

A “child part identifier” column 72 (“child part”) contains an identifier such as a serial number identifying the part to which the row corresponds. A “child part description” column 74 (“child part desc”) includes a brief textual description of the part. Again, the legacy textual description is likely to employ jargon such as abbreviations and acronyms that are not readily understood by those who are not intimately familiar with the machine. For each of the parts, a “quantity description” column 76 (“qty”) identifies the number of the corresponding parts for the machine, assembly and/or sub-assembly. A “unit of measure” column 78 (“UM”) identifies the units of measure in which the quantity is specified. For example, the unit of measurement can be “each” (“EA”) referring to each individual part. An “MPL item number” column 80 (“MLI”) contains a part identifier from the original master parts list. In many cases, the part identifier is the only piece of part information that is not lost or changed as the master parts list evolves into the bill of materials. A “distribution code” column 82 (“code”) identifies a distribution code for the part. A “category identifier” column 84 (“category”) identifies a category to which the part belongs. For example, a part may be a steam valve component (“VL”) or a bearing or oil deflector (“BD”) of a steam turbine.

FIG. 3 also shows a portion of a translation data structure 86 for company's machines. The translation data structure 86 is illustrated as a translation table 88 including parts information for the various parts, assemblies and/or sub-assemblies. The parts identification and tracking system 10 generates the translation data structure from the bill of materials data structure 60, with or without human assistance. A single translation data structure 86 can store all the parts information for one or more machines. Thus, the company can make available a single parts listing for each or all of its products.

The translation table 88 includes a number of rows 90 corresponding to each of the individual parts and/or groups of parts. The translation table 88 also includes a number of columns for detailing information regarding each of the parts. Several of these columns are similar to the columns from the bill of material table 62. For example, an “MPL item number” column (“MLI”) 92 is similar to the “MPL item number” column 80 of the bill of material table 62, containing the part identifier from the original master parts list. A “distribution code” column 94 (“code”) is similar to the “distribution code” column 82 of the bill of materials table 62, containing a distribution code for the part. A “category identifier” column 96 (“category”) is similar to the “category identifier” column 84 of the bill of materials table 62, containing an identifier corresponding to the category to which the part belongs. Additionally, the translation table 88 includes a “title” column 98 (“title”), containing a title for the part, which may be the same as the child part description 74 for the part. The translation table 88 also includes a “plain language title” column 100 (“Extranet title”) containing a plain language version of the title or description of the part. The plain language version of the title or description is written to clearly identify the part to those who likely would be searching for the part, such as a technician, a repair person, or a customer.

The parts identification and tracking system 10 employs a user interface (“UI”) for allowing users, such as technicians, repair persons, and customers, to identify and/or order replacement parts. The parts identification and tracking system 10 implements the UI functionality in software which can reside on the server computing system 14 and/or the client computing system 12. For example, the UI can take the form of a Web site having one or more Web pages hosted on the server computing system 14. The Web pages are transmitted to the client computing systems 12 in response to requests placed by Web browsers executing on the client computing systems 12. Alternatively, the UI can take the form of one or more screens stored in the memory 38 of the client computing system 12, or the server computing system 14.

In response to a user query made via the UI, the server computing system 14 makes one or more database queries of the bill of materials data structure 60 and the translation data structure 86 to generate a response providing requested parts information. The response can take the form of a response data structure 102. The response data structure 102 is illustrated as a response table 104, although other formats may be suitable.

The response table 104 includes a number of rows 106 corresponding to parts and groups of parts satisfying the parameters of the user query. The response table 104 also includes a number of columns for detailing information regarding each of the parts. For example, a “title” column 108 (“Title”) includes a title for the part or group of parts. A “part number” column 110 (“Part #”) includes the corresponding identifier from the “parent” column 68 or “child part identifier” column 72 of the bill of material table 62. A “bill of material quantity” column 112 (“BOM qty”) includes the corresponding number of parts from the “quantity description” column 76 of the bill of material table 62.

An “assembly” column 114 identifies whether the corresponding row identifies an individual part or a group of parts (e.g., assembly, sub-assembly). For example, if a row such as row 116 includes a checkbox 118 in the “assembly” column 114, the row 116 corresponds to a group of parts. Otherwise, the row 116 corresponds to an individual part. The user can select the checkbox 118 to view the individual parts of the group of parts. A check 120 in the checkbox 118 provides a visual indication that the user has selected the checkbox 118. A notation “Part Breakdown” in row 122 indicates that the parts that follow belong to the group of parts.

Some or all of the information from the response data structure 102 can be provided to the user, for example via the display 20 of the client computing system 12. The plain language title 100 provided in the translation table 88 allows people unfamiliar with the precise naming convention employed by designers of the steam turbine to successfully search the parts information.

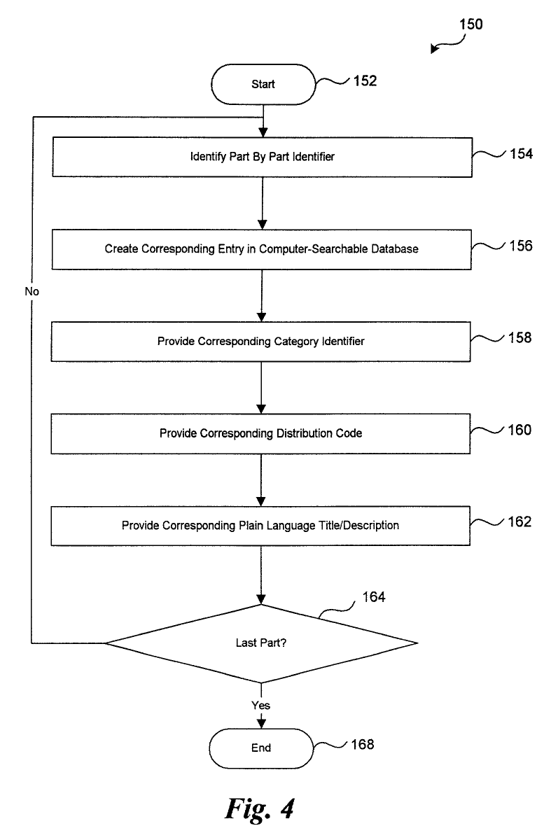

FIG. 4 shows a method 150 of providing legacy parts information in a computer-searchable form, that begins at a start step 152. The method 150 may employ legacy parts information in electronic form, or may require the conversion of legacy parts information from paper form to electronic form, for example by keying or scanning. In particular, FIG. 4 shows the creation of the translation data structure 86 of FIG. 3.

In step 154, the parts identification and tracking system 10 identifies a part using a part identifier. For example, the parts identification and tracking system 10 can employ the MPL item number from the “MPL item number” column 80 of the bill of material table 62 (FIG. 3). In step 156, the parts identification and tracking system 10 creates an entry in the computer-searchable database 34 (FIG. 1) corresponding to the part.

In step 158, the parts identification and tracking system 10 provides a category identifier in the computer-searchable database 34. The category identifier identifies a category to which the part belongs, if any. For example, the parts identification and tracking system 10 can employ the category identifier from the “category identifier” column 84 of the bill of material table 62 (FIG. 3). This allows a user to quickly identify a needed part based on the part's functionality within a system or subsystem. For example, all steam valve-related parts can be rapidly identified under category “VL.”

In step 160, the parts identification and tracking system 10 provides a distribution code to the computer-searchable database 34. The distribution code can identify a salable part or group of parts as a salable unit, filtering out non-salable items from the machine parts list or bill of material such as raw material, manufacturing operations, manufacturing processes and strategic parts not intended to be sold as stand alone parts. For example, the parts identification and tracking system 10 can employ “distribution code” column 82 of the bill of materials table 62 (FIG. 3). This is particularly useful where the parts are intended to be sold via electronic commerce. The parts identification and tracking system 10 can ensure that the user only selects parts in predefined packages. This results in the user receiving all of the parts necessary for a particular repair or rehabilitation job. This also permits the company to pre-package parts, which can later be easily and quickly shipped upon request.

In step 162, the parts identification and tracking system 10 provides a plain language title and/or description in the computer-searchable database 34. The plain language title can be entered by a human, or the parts identification and tracking system 10 can automatically generate the plain language title/description by automatically substituting plain language words for previously defined jargon such as abbreviations and acronyms.

In step 164, the parts identification and tracking system 10 determines if all of the parts for the machine have been entered into the translation data structure 86. If the last part has been entered, the method 150 terminates at an end step 168. If not, control returns to step 154 for creating an entry in the translation data structure 86 for the next part.

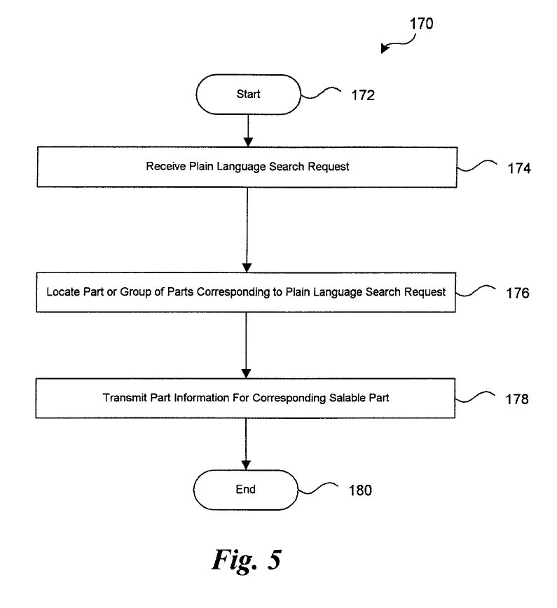

FIG. 5 shows a method 170 of accessing parts information, that starts at step 172. In step 174, the parts identification and tracking system 10 receives a search request in the form of a plain language parts description. For example, a user can submit a plain language description of the part to the server computing system via the keyboard and/or mouse of the client computing system. In step 176, the parts identification and tracking system 10 automatically locates at least one machine part that corresponds to the received plain language parts description. For example, the server computing system 14 can employ a database query of the “plain language title” column 100 of the translation table 88 (FIG. 3). In step 178, the parts identification and tracking system 10 transmits part information to the user for a corresponding salable part. For example, the server computing system 14 can transmit parts information as Web page to the client computing system 12. The method 170 terminates at end step 180.

Although specific embodiments and examples of the invention are described herein for illustrative purposes, various equivalent modifications can be made without departing from the spirit and scope of the invention, as will be recognized by those skilled in the relevant art. The teachings provided herein of the invention can be applied to other parts tracking and distribution systems, not necessarily the exemplary parts tracking and distribution system generally described above. The various embodiments described above can be combined to provide further embodiments. Additionally, or alternatively, the described methods can omit some steps, can add other steps, and can execute the steps in other orders to achieve the advantages of the invention.

These and other changes can be made to the invention in light of the above detailed description. In general, in the following claims, the terms used should not be construed to limit the invention to the specific embodiments disclosed in the specification, but should be construed to include all computers, networks and distribution systems that operate in accordance with the claims. Accordingly, the invention is not limited by the disclosure, but instead its scope is to be determined entirely by the following claims.

I/We claim:

1. A method of providing searchable access to steam turbine machine part data, comprising:
receiving a first set of legacy parts information, the legacy parts information including a unique part identifier for each of a plurality of unique steam turbine parts, the legacy parts information having an abbreviated text description of at least some of the parts;
translating each of the abbreviated text descriptions into a plain language title;
associating the plain language title with the part identifier for the part in an entry in a computer searchable database; and
providing a user interface for accessing the parts information by way of the plain language parts descriptions.

2. The method of claim 1, further comprising:
receiving a search request from the user interface in the form of a plain language parts query;
automatically locating at least one part that corresponds to the received plain language parts query by searching the plain language titles in the database; and
transmitting item information for at least one salable item that includes the located part and at least one other part.

3. The method of claim 1, further comprising:
providing a distribution code in the computer searchable database for each of the parts, the distribution code identifying at least one salable unit to which the part belongs.

4. The method of claim 1, further comprising:
providing a category identifier in the computer searchable database for each of the plurality of the parts, the category identifier associating the part with at least one machine subassembly to which the part belongs.

5. The method of claim 1, further comprising:
providing a distribution code in the computer searchable database for each of the identified unique parts that identifies at least one salable unit to which the part belongs.

6. A method of providing searchable access to steam turbine machine part data, comprising:
receiving a first set of legacy parts information, the legacy parts information including a unique part identifier for each of a plurality of unique steam turbine parts, the legacy parts information having an abbreviated text description of at least some of the parts;
translating each of the abbreviated text descriptions into a plain language title;
associating the plain language title with the part identifier for the part in an entry in a computer searchable database;
receiving a search request in the form of a plain language parts query;
automatically locating at least one part that corresponds to the received plain language parts query by searching the plain language titles in the database; and
transmitting item information for at least one salable item that includes the located part and at least one other part.

7. The method of claim 6 wherein the search request is received in the form of an HTTP request.

8. A system for facilitating access to machine parts information, comprising:
a processor coupled to a first set of legacy parts information, the legacy parts information including a unique part identifier for each of a plurality of unique steam turbine parts, the legacy parts information having an abbreviated text description of at least some of the parts, the processor being programmed to:
translate each of the abbreviated text descriptions into a plain language title; and
associate the plain language title with the part identifier for the part in an entry in a computer searchable database.

9. The system of claim 8 wherein the processor is also programmed to provide a distribution code in the computer searchable database for each of the parts, the distribution code identifying at least one salable unit to which the part belongs.

10. The system of claim 8 wherein the processor is also programmed to provide a category identifier in the computer searchable database for each of the plurality of the parts, the category identifier associating the part with at least one machine subassembly to which the part belongs.
